(19) United States
(12) Patent Application Publication
(10) Pub. No.: US 2005/0127618 A1
(43) Pub. Date: Jun. 16, 2005

(54) Drilling device

(75) Inventor: Hans Baumann, Sontheim (DE)

Correspondence Address: FULBRIGHT & JAWORSKI, LLP, 1301 MCKINNEY, SUITE 5100, HOUSTON, TX, 77010-3095, US

(73) Assignee: Rohm GmbH, Sontheim an der Brenz (DE)

(21) Appl. No.: 10/988,352

(22) Filed: Nov. 12, 2004

(30) Foreign Application Priority Data
Nov. 14, 2003 (DE) 203 17 695.2

(51) Int. Cl. B23B 31/12

(52) U.S. Cl. 279/60

(57) ABSTRACT

The present invention relates to a drilling having a drilling spindle and a drilling chuck, which has a chuck body having clamping jaws adjustable in relation to the chuck axis and having a spindle receiver for the coupling with the drilling spindle. Centering surfaces, which come to rest on one another in the mounted state, are implemented in the spindle receiver and on the drilling spindle, a bayonet ring, having at least one journal pointing radially inward, is mounted so it is rotatable on the chuck body on its side facing toward the drilling spindle, at least one axially oriented journal receiver having an undercut around the circumference is implemented in the drilling spindle, and a cam receiver is provided on the rear axial end of the chuck body facing toward the drilling spindle for rotationally-locked receiving of a cam implemented on the drilling spindle.

### CROSS-REFERENCE TO RELATED APPLICATIONS

This application claims priority to DE 203 17 695.2 filed Nov. 14, 2003.

### TECHNICAL FIELD

The present invention relates to a drilling device comprising a drilling spindle and a drilling chuck, which has a chuck body having clamping jaws adjustable in relation to the chuck axis and having a spindle receiver for the coupling with the drilling spindle.

Drilling devices of this type, in which the coupling between the drilling spindle and the drilling chuck is most frequently produced via a threaded connection, for which the drilling spindle is implemented as a threaded rod and a threaded receiver, through which the drilling chuck may be screwed onto the drilling spindle, is implemented in the end of the chuck body facing axially toward the drilling spindle, are widely distributed in practice. If a sufficiently high torque is applied in this case, there is a secure and lasting connection. However, there is the disadvantage that simple and rapid replacement of the drilling chuck from the drilling device is not possible and is particularly not possible without a tool.

### SUMMARY OF THE INVENTION

The present invention is therefore based on the object of implementing a drilling device of the above-mentioned type in such a way that the replacement of the drilling chuck of the drilling device is simplified.

This object is achieved according to the present invention in a drilling device of the above-mentioned type in that centering surfaces, which come to rest on one another in the mounted state, are implemented in the spindle receiver and on the drilling spindle, a bayonet ring, having at least one journal pointing radially inward, is mounted so it is rotatable on the chuck body on its side facing toward the drilling spindle, at least one axially oriented journal receiver having an undercut around the circumference is implemented in the drilling spindle, and a cam receiver is provided on the rear axial end of the chuck body facing toward the drilling spindle for rotationally-locked receiving of a cam implemented on the drilling spindle.

This embodiment according to the present invention has the advantage that the advantages of a bayonet connection, which is known per se, may also be exploited in the coupling between the drilling spindle and the drilling type, it being ensured through the centering surfaces that, even at the high speeds that occur in the drilling device, no unacceptably great imbalance occurs. Therefore, coaxial alignment of the chuck body and the drilling spindle is ensured by the centering surfaces, while the journal and the journal receiver of the bayonet connection prevent axial displacement of the drilling chuck in the mounted state. However, this coupling provided in conventional bayonet connections is insufficient in a drilling device, since a satisfactory, secure torque transmission is not ensured only through clamping, because of which the interaction of the cam with the cam receiver is provided according to the present invention.

The preferred embodiment of the present invention includes a retaining element positioned in the chuck body on the side facing toward the drilling spindle, which is adjustable between a rotation setting in which the retaining element has the drilling spindle applied to it, and a retaining setting in which the retaining element engages in a retaining receiver of the bayonet ring in the state of the drilling chuck dismounted from the drilling spindle. In principle, is possible that the bayonet ring is freely rotatable in relation to the chuck body. However, to mount the drilling chuck on a drilling machine, it is necessary for a correct alignment of the setting of the bayonet ring with the journal to the journal receiver of the drilling spindle and of the chuck body with the cam receiver in relation to the cam of the drilling spindle to be provided, which must be set by the user initially to begin mounting. This adjustment work is simplified and/or dispensed with by the corresponding refinement of the drilling device using the retaining element, which, in the desired correct rotation setting of the bayonet ring in relation to the chuck body, enters the retaining receiver and allows the mounting of the drilling chuck in the framework of a plugging movement onto the drilling spindle.

It has been shown to be especially advantageous if the retaining element is implemented as an axially oriented retaining pin, which has the force of a spring acting in the retaining setting applied to it.

Furthermore, it is expedient if the retaining element is positioned in the cam receiver, since, in this way, when the drilling chuck and the drilling spindle are put together, they displace the retaining element into the rotation setting through the cam entering the cam receiver.

In order to achieve good reproducibility of the connection between the drilling chuck and the drilling spindle, specific planar surfaces, which are intended to rest on one another in the mounted state, are implemented on the drilling spindle and the chuck body to determine the axial position. These planar surfaces ensure, by interacting with the centering surfaces, precisely defined positioning of the drilling chuck with its chuck body in relation to the drilling spindle of a drilling machine.

The journal and the journal receiver are provided multiple times to improve the security of the connection between the drilling chuck and the drilling spindle, a symmetrical construction, whose concentric properties are improved, being provided simultaneously if they are distributed uniformly around the circumference.

Furthermore, it is provided in the scope of the present invention that the surfaces of the journal intended for interaction with the journal receivers have a slope like a thread. The advantage is connected therewith that when the bayonet ring is twisted the chuck body is pulled solidly against the drilling spindle and solid contact of the planar surfaces is achieved in particular.

A further embodiment that is very especially preferred in the scope of the present invention is distinguished in that a locking device that acts in the mounted state of the drilling spindle is implemented between the bayonet ring and the chuck body. The retaining element, which is implemented as a retaining pin, acts to prevent twisting of the bayonet ring in relation to the chuck body when the drilling chuck is not mounted on the drilling spindle, while the retaining element is inactive in the mounted state. The locking device is thus used to suppress undesired twisting of the bayonet ring in relation to the chuck body in the mounted state, since this twisting may cause loosening of the connection between the chuck body and the drilling spindle. The locking device is thus particularly used for the purpose of reliably controlling vibrations, which could occur in the drilling operation and which may cause twisting of the bayonet ring, and suppressing undesired displacement of the bayonet ring.

For this purpose, it suggests itself for the locking device to have locking teeth assigned to the chuck body and a locking element assigned to the bayonet ring that is adjustable through a rotation of the bayonet ring in relation to a control ring having a control curve, between the state engaged in the locking teeth and the state disengaged from the locking teeth.

A design in which the locking element is implemented as a spring clip extending around the circumference, which has a locking tooth on one free end to which a control cam for interaction with the control curve is assigned, has been shown to be especially reliable and simple to operate.

If a catch cam is implemented in the spring clip for interaction with one of two catch seats at a time in the engaged state or disengaged state of the locking element, the size of the torque that must be applied by the user in order to twist the bayonet ring to actuate the locking device is defined by this catch device formed by the catch cams and the catch seats.

### BRIEF DESCRIPTION OF THE DRAWINGS

In the following, the present invention will be explained in greater detail on the basis of the exemplary embodiments illustrated in the drawing:

FIG. 1 is a longitudinal section through a drilling spindle and a drilling chuck as part of the drilling device according to the present invention;

FIG. 2 is an illustration, corresponding to FIG. 1, of a drilling chuck having a retaining pin acting between the chuck body and the bayonet ring;

FIG. 3 is a top view from the direction of the arrow III from FIG. 2;

FIG. 4 is the section IV-IV from FIG. 2;

FIG. 5 is the section V-V from FIG. 2 with the locking device in the disengaged state; and

FIG. 6 is an illustration corresponding to FIG. 5 with the locking device in the engaged state.

### DETAILED DESCRIPTION OF THE PREFERRED EMBODIMENT

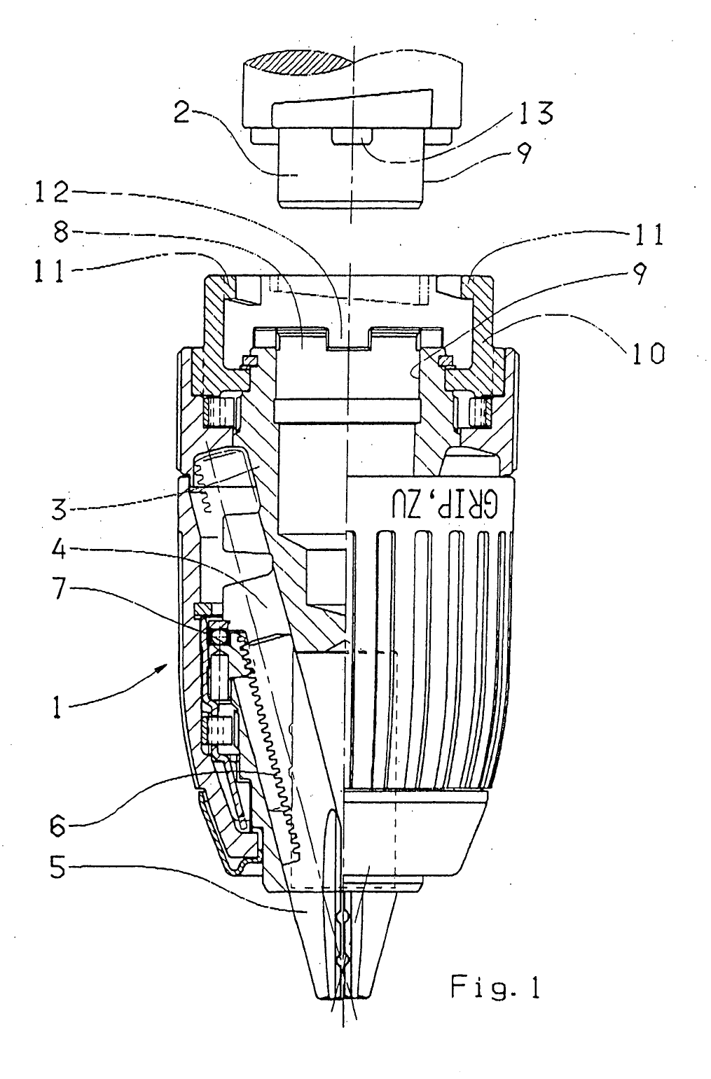

In FIG. 1 of the drawing, only the drilling chuck 1 and the drilling spindle 2, intended for coupling with the drilling chuck 1, of a drilling device formed by a drilling machine and a drilling chuck 1 are shown. The drilling chuck 1 has a chuck body 3 having guide receivers 4, running diagonally to the chuck axis, in which clamping jaws 5 are guided so they are displaceable lengthwise, which engage using a row of teeth 6 with the internal thread of a threaded ring 7, which is guided on the chuck body 3 so that it is rotatable. On the rear axial end of the chuck body 3, facing toward the drilling spindle 2, a spindle receiver 8 is implemented that has a centering surface 9, which comes to rest in the mounted state on a centering surface 9 of the drilling spindle 2. The chuck body 3 and the drilling spindle 2 are connected using a bayonet ring 10, mounted on the chuck body 3 so it is rotatable, having at least one (four in the drawing) journal 11 directed radially inward, which engage in a corresponding number of journal receivers in the drilling spindle 2 to mount the drilling chuck 1 on the drilling spindle 2, each journal receiver having an undercut around the circumference, into which the journals 11 are inserted like a bayonet connection to prevent axial displacement of the chuck body 3 in relation to the drilling spindle 2. A cam receiver 12, for rotationally-locked receiving of a cam 13 implemented on the drilling spindle 2, is provided on the rear axial end of the chuck body 3 facing toward the drilling spindle 2 to transmit a sufficiently high torque.

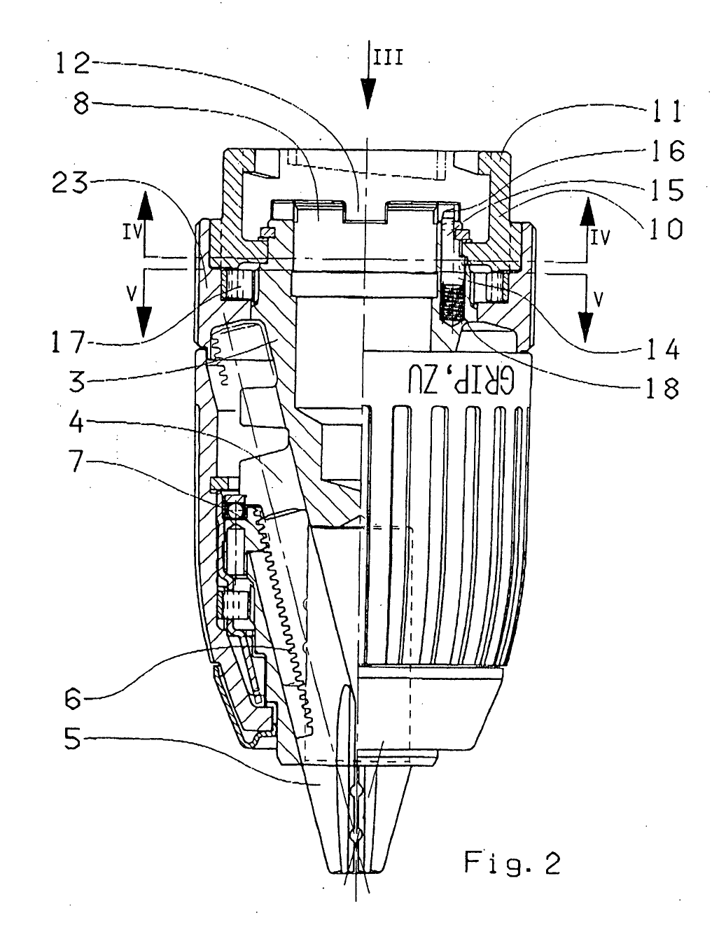

FIG. 2 shows an embodiment in which a retaining element 14, implemented as a retaining pin 15, is positioned in the chuck body 3 on the side facing toward the drilling spindle 2, which is adjustable between a rotation setting, in which the drilling spindle 2 is applied to the retaining element 14, and a retaining setting, in which the retaining element 14, in the state of the drilling chuck 1 dismounted from the drilling spindle 2, engages in a retaining receiver 16 of the bayonet ring 10. The retaining pin 15 is placed axially oriented in the chuck body 3 in this case and has the force of a spring 18 applied to it, which attempts to displace the retaining pin 15 into the retaining setting.

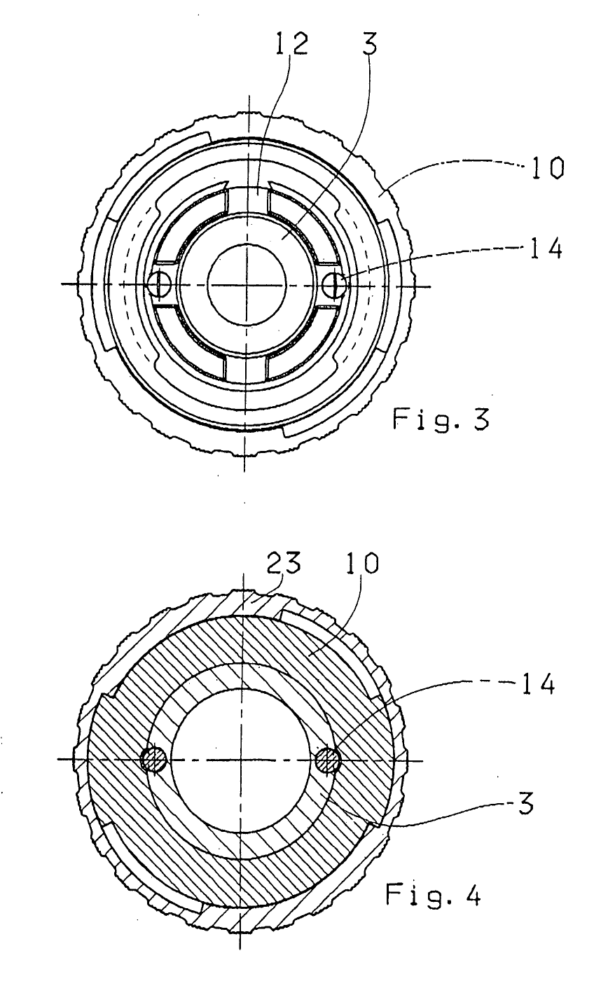

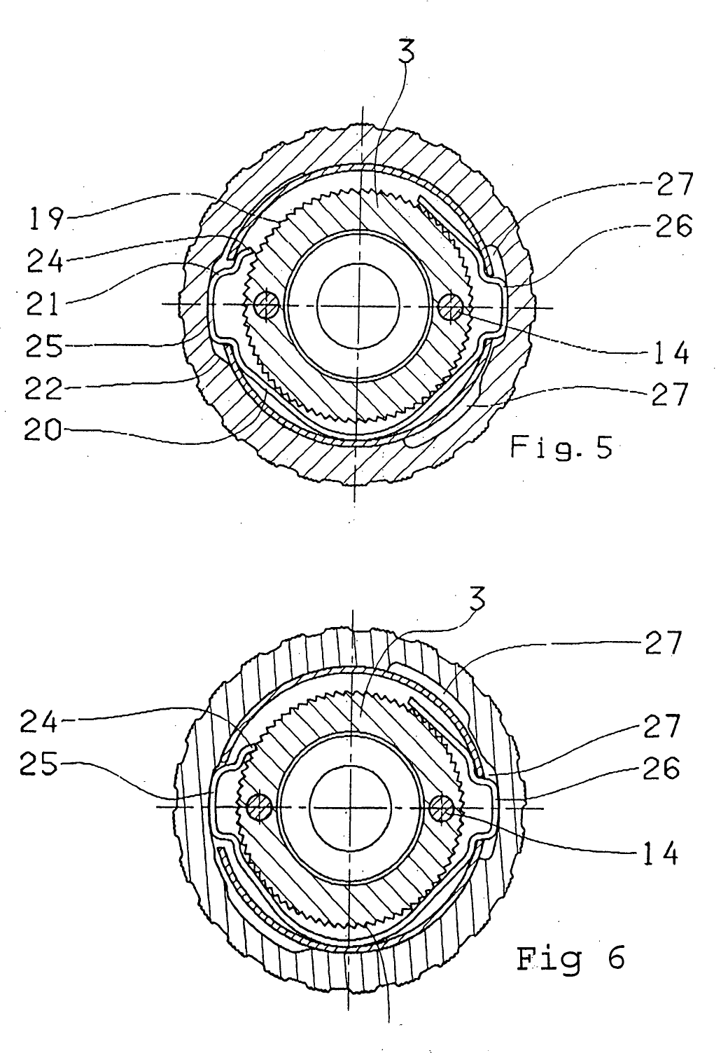

As may be seen from FIGS. 3 and 4, in particular, the retaining element 14 is positioned in the cam receiver 12.

Both FIG. 1 and FIG. 2 show that the surfaces of the journal 11 intended for interaction with the journal receivers form a slope like a thread and thus cause the chuck body 3 to be pressed against the drilling spindle 2 in the axial direction, in particular to come to rest on the planar surfaces, when the journals 11 are introduced into the undercuts of the journal receivers.

Furthermore, the drilling chuck 1 shown in the drawing has a lock device 17 implemented between the bayonet ring 10 and the chuck body 3 and acting in the mounted state of the drilling spindle 2, which suppresses twisting of the bayonet ring 10 in relation to the chuck body 3. The locking device 17, which may be seen in more detail from FIGS. 5 and 5A, includes locking teeth 19 assigned to the chuck body 3 and a locking element 21 assigned to the bayonet ring 10 and implemented as a spring clip 20, which is adjustable, through rotation of the bayonet ring 10 in relation to a control ring 23 having a control curve 22, between the state engaged in the locking teeth 19 and the state disengaged from the locking teeth. On its free end, the spring clip 20 has a locking tooth 24, to which a control cam 25 is assigned for interaction with the control curve 22. Furthermore, a catch cam 26 is implemented in the spring clip 20 that interacts with one of two catch seats 27 at a time in the engaged state or disengaged state of the locking element 21, depending on the rotation setting of the control ring 23.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

1. A drilling device, comprising:
a drilling chuck comprising a chuck body, a spindle receiver, a bayonet ring, a cam receiver, and clamping jaws, said drilling chuck having a longitudinal axis,
said chuck body having a rear axial end,
said clamping jaws adjustable in relation to the longitudinal axis of the drilling chuck,
said spindle receiver having first centering surfaces,
said bayonet ring having a journal directed radially inward and rotatable on the chuck body, and
said cam receiver located at the rear axial end of the chuck body; and
a drilling spindle comprising a cam, an axially oriented journal receiver, and second centering surfaces,
said second centering surfaces adapted to contact the first centering surfaces such that said drilling spindle is aligned with the longitudinal axis of the drilling chuck.

2. The drilling device of claim 1, further comprising a retaining element positioned in the chuck body at the rear axial end, wherein said retaining element is adjustable between a rotation setting, in which the drilling spindle is applied to the retaining element, and a retaining setting, in which the retaining element engages in a retaining receiver of the bayonet ring.

3. The drilling device of claim 2, wherein the retaining element is an axially oriented retaining pin.

4. The drilling device of claim 3, wherein the retaining element is positioned in the cam receiver.

5. The drilling device of claim 2, wherein the retaining element is positioned in the cam receiver.

6. The drilling device of claim 1, wherein the drilling spindle further comprises a first planar surface and the chuck body further comprises a second planar surface adapted to contact the first planar surface such that the axial position of the drilling spindle may be determined in relation to the chuck body.

7. The drilling device of claim 1, wherein said bayonet ring comprises a plurality of journals, and said drilling spindle comprises a plurality of journal receivers.

8. The drilling device of claim 7, wherein each journal comprises a thread-like sloped surface and wherein the journal receivers are adapted to receive said thread-like sloped surfaces.

9. The drilling device of claim 1, wherein the journal comprises a thread-like sloped surface and wherein the journal receiver is adapted to receive said thread-like sloped surface.

10. The drilling device of claim 1, further comprising a locking device located between the bayonet ring and the chuck body.

11. The drilling device of claim 10, wherein the locking device comprises
locking teeth located on the chuck body;
a locking element located on the bayonet ring; and
a control ring having a control curve;
wherein the locking element may be adjusted to engage or disengage the control teeth by rotating the bayonet ring in relation to the control.

12. The drilling device of claim 11, wherein the locking element comprises
a spring clip extending around the circumference of the bayonet ring;
a locking tooth on one end; and
a control cam assigned to the locking tooth and adapted for interacting with the control curve.

13. The drilling device of claim 12, further comprising a catch cam implemented in the spring clip for interaction with one of two catch seats at a time in the engaged state or disengaged state of the locking element.
